(19) United States
(12) Patent Application Publication
(10) Pub. No.: US 2026/0327406 A1
(43) Pub. Date: Oct. 22, 2026

(54) RUST-PREVENTING FILM

(71) Applicant: AICELLO CORPORATION, Toyohashi-shi, Aichi (JP)

(72) Inventors: Shiro SAWADA, Aichi (JP); Seiji TORIYAMA, Aichi (JP)

(73) Assignee: AICELLO CORPORATION, Toyohashi-shi, Aichi (JP)

(21) Appl. No.: 19/113,809

(22) PCT Filed: Aug. 21, 2023
(86) PCT No.: PCT/JP2023/029927

§ 371 Date: Mar. 20, 2025

(30) Foreign Application Priority Data
Oct. 6, 2022 (JP) 2022-161490

(51) Int. Cl. C08K 5/098; B32B 27/08; B32B 27/32; C08J 3/20; C08K 3/28; C08K 5/205

(52) U.S. Cl. CPC C08K 5/098; B32B 27/08; B32B 27/32; C08J 3/201; C08K 3/28; C08K 5/205; B32B 2307/712; C08J 2323/06

(57) ABSTRACT

The present invention effectively utilizes a recovered rust-preventing film to obtain a recycled resin composition for a rust-preventing film, which is a recycled resin, through treatment under a milder condition. The present invention provides a recycled resin composition for a rust-preventing film, containing: a polyolefin resin; 0.02 wt % to 0.20 wt % of a vaporizable amine and/or ammonia-based rust-preventing agent; a deliquescent rust-preventing agent; and 0.30 wt % or less of water.

### TECHNICAL FIELD

The present invention relates to a rust-preventing film.

### BACKGROUND ART

As described in Patent Literature 1, there is known a rust-preventing film that includes a resin molded product including a resin layer containing an ammonium carboxylate having an average particle diameter of 20 μm or more, and a substrate layer containing one or more kinds of a metal nitrite, a carboxylic acid, a benzotriazole-based compound, a tolyltriazole-based compound, and a metal carboxylate.

However, it is not known to recover and reuse such a known rust-preventing film containing two or more kinds of rust-preventing agents after use. In order to recover such a rust-preventing film to reuse it as a resin for a rust-preventing film and to add an arbitrary rust-preventing agent thereto, it has been necessary to completely remove the existing rust-preventing agent, since there is a combination in which the rust-preventing agents react with each other during coexistence, among combinations of two or more kinds of rust-preventing agents. However, this requires a huge amount of work.

That is, in a rust-preventing film having, for example, two or more layers, rust-preventing agents contained in the layers are generally different rust-preventing agents. In particular, there is known a combination of rust-preventing agents that react with each other to generate a gas when mixed together, and in the case of such a combination, it has been necessary to particularly form the rust-preventing film in two or more layers.

### CITATION LIST

### Patent Literature

Patent Literature 1: WO2018/079458

### SUMMARY OF INVENTION

### Technical Problem

In the present invention, a recovered rust-preventing film having two layers, i.e., a resin layer containing a vaporizable amine and/or ammonia-based rust-preventing agent and a resin layer containing a deliquescent rust-preventing agent, can be effectively utilized to obtain a recycled resin composition for a rust-preventing film, which is a recycled resin, using a treatment under milder conditions. By using the recycled resin composition for a rust-preventing film, a new rust-preventing film can be produced without foaming, and a combination of rust-preventing agents that cannot originally be contained in one layer can be contained in one layer. Another object is to obtain a rust-preventing film having more sufficient rust-preventing performance and containing a recycled resin composition for a rust-preventing film, thereby promoting the reuse of the used rust-preventing film.

### Solution to Problem

As a result of intensive studies to solve the above problems, the inventors of the present invention have found that the problems can be solved by the following methods, and have thus completed the present invention.
1. A recycled resin composition for a rust-preventing film, containing: a polyolefin resin; 0.02 wt % to 0.20 wt % of a vaporizable amine and/or ammonia-based rust-preventing agent; a deliquescent rust-preventing agent; and 0.30 wt % or less of water.
2. A method for producing a recycled resin composition for a rust-preventing film, including: melting, kneading, and, if necessary, drying a rust-preventing film having a laminated structure including a polyolefin resin layer containing a vaporizable amine and/or ammonia-based rust-preventing agent and a polyolefin resin layer containing a deliquescent rust-preventing agent, in which the recycled resin composition for a rust-preventing film contains a polyolefin resin, 0.02 wt % to 0.20 wt % of the vaporizable amine and/or ammonia-based rust-preventing agent, the deliquescent rust-preventing agent, and 0.30 wt % or less of water.
3. A rust-preventing film having a laminated structure including a polyolefin resin layer 1 containing a vaporizable amine and/or ammonia-based rust-preventing agent and a polyolefin resin layer 2 containing a deliquescent rust-preventing agent, in which the polyolefin resin layer 2 contains a polyolefin resin, 20 ppm to 220 ppm of a vaporizable amine and/or ammonia-based rust-preventing agent, and 400 ppm or less of water, which are derived from a recycled resin composition for a rust-preventing film.
4. The rust-preventing film according to 3, in which a YI value measured by stacking 12 rust-preventing films is 35.0 or less.
5. A method for producing a rust-preventing film, the rust-preventing film having a laminated structure including a polyolefin resin layer 1 containing a vaporizable amine and/or ammonia-based rust-preventing agent and a polyolefin resin layer 2 containing a deliquescent rust-preventing agent, the method including: mixing the polyolefin resin layer 2 with a recycled resin composition for a rust-preventing film, a polyolefin resin, and the deliquescent rust-preventing agent, to contain 20 ppm to 220 ppm of the vaporizable amine and/or ammonia-based rust-preventing agent and 400 ppm or less of water, which are derived from the recycled resin composition.

### Advantageous Effects of Invention

According to the present invention, a used rust-preventing film, rust-preventing bag or the like including two layers, i.e., a resin layer containing a vaporizable amine and/or ammonia-based rust-preventing agent and a resin layer containing a deliquescent rust-preventing agent, is recovered and the recovered material is subjected to a treatment for recycling, whereby the recovered material can be reused as a recycled resin composition for producing a rust-preventing film in a state where a certain amount of the vaporizable amine and/or ammonia-based rust-preventing agent is contained and in a state where the deliquescent rust-preventing agent is contained. Hereinafter, it will simply be referred to as a “recycled resin composition for a rust-preventing film”.

The recycled resin composition for a rust-preventing film after recycling the used rust-preventing film, rust-preventing bag or the like contains 0.02 wt % to 0.20 wt % of the vaporizable amine and/or ammonia-based rust-preventing agent that has not been completely removed, and further contains a deliquescent rust-preventing agent and 0.30 wt % or less of water.

In this way, since the recycled resin composition for a rust-preventing film from which the rust-preventing agent is not completely removed, the recovered rust-preventing bag or the like does not have to be subjected to a treatment under harsher conditions such as temperature and time (a treatment under harsh conditions for completely removing the rust-preventing agent), and can be subjected to a treatment for recycling under milder conditions such as temperature and time. Therefore, it is possible to reduce an amount of energy required to obtain a composition for a rust-preventing film from the recovered material, and to reduce an amount of energy required to obtain a new rust-preventing film. This is preferred in that the amount of energy required can be reduced compared to the case of subjecting the recovered material to a treatment to completely remove the rust-preventing agent to obtain a recycled resin.

A new rust-preventing film produced by using this recycled resin composition for a rust-preventing film or a rust-preventing bag obtained therefrom contains only a small content of vaporizable rust-preventing agents coexisting in the resin layer, which therefore do not react with a deliquescent rust-preventing agent. As a result, there is no foaming or discoloration, such as yellowing, during film formation. When foaming occurs during the film formation, film-forming properties deteriorate and mechanical properties of the obtained film deteriorate. In addition, when discoloration such as yellowing occurs, visibility deteriorates. The cause of the discoloration such as yellowing is oxidation of the resin or the deliquescent rust-preventing agent during the process of producing the recycled resin composition for a rust-preventing film.

Further, a new resin layer produced by using this recycled resin composition for a rust-preventing film and a resin layer containing a vaporizable amine and/or ammonia-based rust-preventing agent can be laminated to form a new laminated rust-preventing film having a sufficient rust-preventing property.

That is, even with such a recycling method under milder conditions, the rust-preventing film according to the present invention can be used as a rust-preventing film with a rust-preventing performance equivalent to that of a rust-preventing film containing materials not obtained by reuse. Therefore, the cost, time, and environmental burden associated with recycling and reuse can be reduced, and the reuse of the used rust-preventing film can be promoted.

### DESCRIPTION OF EMBODIMENTS

### <Recycled Resin Composition for Rust-Preventing Film>

A recycled resin composition for a rust-preventing film according to the present invention is a composition used mainly for obtaining, in particular, a polyolefin resin layer 2 in a rust-preventing film according to the present invention. It can also be used to obtain other rust-preventing films.

The recycled resin composition for a rust-preventing film is obtained by recovering and recycling one or more kinds of rust-preventing films that have been produced and used, rust-preventing bags obtained therefrom, scraps of the produced rust-preventing film, and surplus rust-preventing films or products.

The rust-preventing film before recovery is a rust-preventing film including a resin layer containing a vaporizable amine and/or ammonia-based rust-preventing agent and a resin layer containing a deliquescent rust-preventing agent laminated together.

The recycling method will be described later.

The recycled resin composition for a rust-preventing film according to the present invention contains a polyolefin resin, and may contain the vaporizable amine and/or ammonia-based rust-preventing agent in a content of at least 0.02 wt %. Making the content less than 0.02 wt % requires an extensive treatment, and in some cases can result in a deterioration of the physical properties of the resin itself. The larger the content of the vaporizable amine and/or ammonia-based rust-preventing agent in the composition obtained by recycling the recovered rust-preventing film, the milder the conditions for the recycling treatment can be. However, when attempting to obtain a new rust-preventing film by blending a larger amount of the recycled resin composition for a rust-preventing film, the larger the content of the vaporizable amine and/or ammonia-based rust-preventing agent in the recycled resin composition for a rust-preventing film, the less the amount of the recycled resin composition for a rust-preventing film that can be used to produce a new rust-preventing film. When the amount of the recycled resin composition for a rust-preventing film used is too large, the vaporizable amine and/or ammonia-based rust-preventing agent may react with the deliquescent rust-preventing agent such as a nitrite during a process of producing a new rust-preventing film, causing foaming of the polyolefin resin layer 2. In addition, the obtained rust-preventing film may be subjected to yellowing or discoloration, and visibility may deteriorate.

Therefore, in the recycled resin composition for a rust-preventing film to be used as a raw material for newly producing a rust-preventing film, the content of the vaporizable amine and/or ammonia-based rust-preventing agent is preferably 0.20 wt % or less, more preferably 0.15 wt % or less, and still more preferably 0.10 wt % or less.

A content of the deliquescent rust-preventing agent in the recycled resin composition is not particularly limited, and is preferably 0.28 wt % or less, more preferably 0.25 wt % or less, and still more preferably 0.22 wt % or less. In addition, it is preferably 0.05 wt % or more, more preferably 0.07 wt % or more, and still more preferably 0.10 wt % or more. In the case where the content of the deliquescent rust-preventing agent is too large, a content of water increases due to moisture absorption, and there is a greater concern that the water evaporates and foams when obtaining a new rust-preventing film by using the recycled resin composition for a rust-preventing film. Making the content of the deliquescent rust-preventing agent less than 0.05 wt % requires a treatment under correspondingly harsher conditions such as temperature and time.

In addition, the recycled resin composition for a rust-preventing film preferably has a small content of water. The water comes from moisture absorption by the deliquescent rust-preventing agent contained in the recycled resin composition. The content of the water is preferably 0.30 wt % or less, more preferably 0.20 wt % or less, still more preferably 0.10 wt % or less, and most preferably 0.05 wt % or less. In the case where the content of the water is too large, when obtaining a new rust-preventing film by using the recycled resin composition for a rust-preventing film, the water may evaporate and foam, or may cause deliquescence of the deliquescent rust-preventing agent contained in the new rust-preventing film, such as a nitrite. As a result, the amount of the recycled resin composition for a rust-preventing film that can be used to produce the new rust-preventing film may be inevitably reduced.

### <Method for Producing Recycled Resin Composition for Rust-Preventing Film>

The recycled resin composition for a rust-preventing film according to the present invention is a composition that is recycled from a recovered rust-preventing film including two layers, i.e., a resin layer containing a vaporizable amine and/or ammonia-based rust-preventing agent and a resin layer containing a deliquescent rust-preventing agent, or the like. Note that the recovered rust-preventing film referred to here includes not only one that has been used as a rust-preventing film for packaging, but also a rust-preventing film that has not been used due to a production loss or the like, and materials thereof.

Note that the rust-preventing film to be recovered is preferably a film that falls within the scope of the rust-preventing film according to the present invention.

In addition, the same vaporizable amine and/or ammonia-based rust-preventing agent as above may be that contained in the rust-preventing film to be recovered. Further, a certain amount of the recovered rust-preventing film recovered for recycling may include a rust-preventing film that does not contain the vaporizable amine and/or ammonia-based rust-preventing agent. However, it is preferable that the entire recovered rust-preventing film to be recycled include a rust-preventing film including a resin layer containing a vaporizable amine and/or ammonia-based rust-preventing agent and a resin layer containing a deliquescent rust-preventing agent, such as the rust-preventing film according to the present invention.

Note that the recycled resin composition for a rust-preventing film according to the present invention is obtained from the rust-preventing film that has been once recovered, and the rust-preventing film according to the present invention is newly obtained by using this recycled resin composition for a rust-preventing film. This newly obtained rust-preventing film may be recovered again after use and recycled into a recycled resin composition for a rust-preventing film according to the present invention, and the obtained recycled resin composition for a rust-preventing film according to the present invention may be used again for producing the rust-preventing film according to the present invention, and this process may be repeated.

As a method for producing such a recycled resin composition for a rust-preventing film, use can be made of a method in which the recovered rust-preventing film is pulverized by any means, heated and melted at a high temperature of 140° C. or higher to promote vaporization and disappearance, followed by solidification and pelletizing by any means, and then drying at about 80° C. to 95° C. for about 60 minutes to 150 minutes, if necessary. Note that the conditions such as temperature and time can be changed depending on the conditions related to a device and the recovered rust-preventing film.

By using such heating, melting, and drying means, not only the content of water but also the content of the vaporizable amine and/or ammonia-based rust-preventing agent is reduced to obtain the recycled resin composition for a rust-preventing film according to the present invention.

With such a method for producing a recycled resin composition for a rust-preventing film, it is possible to actively recover and reuse the used rust-preventing film or the like, which has previously been difficult to reuse as a resin composition for a rust-preventing film.

The recycled resin composition for a rust-preventing film according to the present invention, which contains a polyolefin resin, 0.02 wt % to 0.20 wt % of a vaporizable amine and/or ammonia-based rust-preventing agent, a deliquescent rust-preventing agent, and 0.30 wt % or less of water, and a production method therefor are mainly intended to provide a composition for obtaining the rust-preventing film according to the present invention and a production method therefor. The recycled resin composition for a rust-preventing film may be used to produce a rust-preventing film having three or more layers.

### <Rust-Preventing Film>

The rust-preventing film according to the present invention has a basic configuration including a polyolefin resin layer 1 containing a vaporizable amine and/or ammonia-based rust-preventing agent and a polyolefin resin layer 2 containing a deliquescent rust-preventing agent laminated together, and the polyolefin resin layer 2 contains 20 ppm to 220 ppm of a vaporizable amine and/or ammonia-based rust-preventing agent, a deliquescent rust-preventing agent, and 400 ppm or less of water, which are derived from a recycled resin composition for a rust-preventing film.

Note that it is preferable that the polyolefin resin layer 1 and the polyolefin resin layer 2 be directly laminated together, but an adhesive layer, an intermediate layer, or the like may be formed between the polyolefin resin layer 1 and the polyolefin resin layer 2. In addition, an optional layer may or may not be provided on a surface of the polyolefin resin layer 1 opposite to a surface on a polyolefin resin layer 2 side and/or a surface of the polyolefin resin layer 2 opposite to a surface on a polyolefin resin layer 1 side.

Hereinafter, the polyolefin resin layer 1 and the polyolefin resin layer 2 may be simply referred to as a “resin layer 1” and a “resin layer 2”, respectively.

The rust-preventing film according to the present invention may be processed into a bag shape such that the resin layer 1 is on the inner side, that is, the side facing a packaged item, and the resin layer 2 is on the outer side. In the case where there are three or more layers, the resin layer 2 may be provided as the innermost layer. These are used to package metal-made electrical products, electrical parts, electronic parts, mechanical parts, automotive parts, and the like.

In the rust-preventing film according to the present invention, a YI value measured by stacking 12 rust-preventing films is preferably 35.0 or less, more preferably 30.0 or less, still more preferably 25.0 or less, and most preferably 20.0 or less. In the case where the YI value is 35.0 or less, the rust-preventing film produced by using the recycled resin composition for a rust-preventing film does not show a particular discoloration (yellowing), and when used for packaging as a rust-preventing film or a rust-preventing bag, the contents can be visually seen without opening the package.

In addition, known additives such as an antiblocking agent (AB agent), a lubricant, an antioxidant, an antistatic agent, a UV absorber, a light stabilizer, an oxygen absorber, an acid absorber, a flame retardant, a nucleating agent, an impact strength enhancer, a plasticizer, a release agent, a colorant, a fluorescent agent, a compatibilizer, an anti-fogging agent, a filler, an auxiliary colorant, a dispersant, a stabilizer, a modifier, and an antibacterial and antifungal agent may be added to the resin layers 1 and 2 independently within the range that does not impair the effects of the present invention. However, it is necessary that the additive does not react with other components contained in the resin layer 1 and the resin layer 2, and that the additive does not contaminate a packaged item by, for example, bleeding out, for example.

Note that, for the purpose of retaining the rust-preventing agent in the resin layer, an ionomer resin or a functional group-containing polyolefin resin may or may not be blended in the resin layer 1 or the resin layer 2. Then, according to the present invention, the rust-preventing property can be sufficiently exhibited for a long period of time.

The thickness of each of the resin layers 1 and 2 is preferably 10 μm or more, more preferably 15 μm or more, and still more preferably 20 μm or more. In addition, the thickness is preferably 300 μm or less, more preferably 200 μm or less, and still more preferably 100 μm or less. Further, the total thickness of the resin layers 1 and 2 is preferably 20 μm or more, more preferably 30 μm or more, and still more preferably 40 μm or more. In addition, the total thickness is preferably 600 μm or less, more preferably 400 μm or less, and still more preferably 200 μm or less.

Regarding the rust-preventing film according to the present invention, a resin that can be commonly used for both the resin layer 1 and the resin layer 2 will be described. For each of the resin layer 1 and the resin layer 2, one or more kinds of resins may be independently selected from the following resins and used.

### (Polyolefin Resin)

Compositions of the polyolefin resins contained in the resin layer 1 and the resin layer 2 may be different from or same as each other. The compositions are preferably the same since when the rust-preventing film is recovered after use or the like and recycled, it can be used as a rust-preventing film having the same resin composition as that of the rust-preventing film before recycling.

As such a polyolefin resin, one or more kinds selected from polyolefin-based polymers, that is, olefin homopolymers and/or copolymers using an olefin as a monomer, can be selected and used.

Examples of the olefin constituting the polyolefin-based polymer (olefin monomer) include ethylene, propylene, 1-butene, 3-methyl-1-butene, 1-pentene, 3-methyl-1-pentene, 4-methyl-1-pentene, 1-hexene, and 1-octene. Therefore, examples of the polyolefin-based polymer include an ethylene-based polymer, a propylene-based polymer, a 1-butene-based polymer, a 1-hexene-based polymer, and a 4-methyl-1-pentene-based polymer. These polymers may be used alone or in combination of two or more kinds thereof. That is, the polyolefin-based polymer may be a mixture of various polymers.

Among the above, examples of the ethylene-based polymer include an ethylene homopolymer (polyethylene) and a copolymer of ethylene with another monomer (ethylene copolymer). Examples of the ethylene homopolymer and the ethylene copolymer include a low-density polyethylene (LDPE), a linear low-density polyethylene (LLDPE), a medium-density polyethylene (MDPE), and a high-density polyethylene (HDPE).

In addition, examples of the ethylene copolymer include an ethylene-propylene copolymer, an ethylene-1-butene copolymer, an ethylene-1-pentene copolymer, an ethylene-1-hexene copolymer, an ethylene-1-octene copolymer, and an ethylene-4-methyl-1-pentene copolymer.

Note that the ethylene unit (structural unit derived from ethylene) contained in the ethylene copolymer is considered sufficient when more than 50% of the total number of structural units (generally 99.999% or less), and can be, for example, 80.0% to 99.999%, 90.0% to 99.995%, or 99.0% to 99.990% of the total number of structural units.

In addition, examples of the propylene-based polymer include a propylene homopolymer (polypropylene) and a copolymer of a propylene with another monomer (propylene copolymer). Examples of the propylene copolymer include a propylene-ethylene copolymer, a propylene-1-butene copolymer, a propylene-1-pentene copolymer, and a propylene-1-octene copolymer.

Note that the propylene unit (structural unit derived from propylene) contained in the propylene copolymer is considered sufficient when 50% or more of the total number of structural units (generally 99.999% or less), and can be, for example, 80.0% to 99.999%, 90.0% to 99.995%, or 99.0% to 99.990% of the total number of structural units.

In addition, the polyolefin-based polymer may contain structural units derived from monomers other than olefins as long as the object of the present invention is not impaired. Examples of the monomer other than olefins include unsaturated carboxylic acids (acrylic acid, methacrylic acid, maleic acid, and fumaric acid, etc., unsaturated carboxylates (methyl acrylate, ethyl acrylate, butyl acrylate, methyl methacrylate, ethyl methacrylate, butyl methacrylate, dimethyl maleate, and diethyl maleate, etc.), vinyl esters (vinyl acetate, vinyl propionate, and maleic acid monoester, etc.). These may be used alone or in combination of two or more kinds thereof.

Note that, when contained, the structural unit derived from the monomer other than olefins is preferably 40% or less (generally 0.001% or more) of the total number of structural units contained in the polyolefin-based polymer. For example, it can be 0.001% to 25%, 0.005% to 15%, or 0.01% to 10% of the total number of structural units.

The polyolefin-based resin preferably has a density of 0.880 g/cm3 to 0.950 g/cm3 from the viewpoint of processability. In addition, it preferably has a melt flow rate (MFR) in a range of 1.0 g/10 min to 10.0 g/10 min from the viewpoint of mechanical strength and processability. With an appropriate viscosity during melt processing, it is possible to contain and cover a particulate ammonium carboxylate in the resin, and it is possible to prevent the rust-preventing agent from falling off from a resin molded product.

### (Resin Layer 1)

The resin layer 1 contains a vaporizable amine and/or ammonia-based rust-preventing agent as the rust-preventing agent.

The vaporizable amine and/or ammonia-based rust-preventing agent may be any of an aliphatic ammonium carboxylate, an aliphatic amine carboxylate, an aromatic ammonium carboxylate, and an aromatic amine carboxylate.

Use can be made of one or more kinds from, for example, ammonium salts of aliphatic carboxylic acids such as butyric acid, isobutyric acid, methacrylic acid, valeric acid, caproic acid, caprylic acid, capric acid, lauric acid, tridecylic acid, myristic acid, palmitic acid, stearic acid, sorbic acid, oleic acid, oleylic acid, isohexanoic acid, 2-methylpentanoic acid, 2-ethylbutanoic acid, isoheptanoic acid, isooctanoic acid, 2-ethylhexanoic acid, isononanoic acid, isodecanoic acid, 2-propylheptanoic acid, isoundecanoic acid, isododecanoic acid, 2-butyloctanoic acid, oxalic acid, malonic acid, succinic acid, glutaric acid, adipic acid, pimelic acid, suberic acid, azelaic acid, sebacic acid, undecanedicarboxylic acid, and dodecanedioic acid, ammonium salts of aromatic carboxylic acids such as benzoic acid, aminobenzoic acid, salicylic acid, p-tert-butylbenzoic acid, o-sulfobenzoic acid, 1-naphthoic acid, 2-naphthoic acid, phthalic acid, isophthalic acid, terephthalic acid, and cinnamic acid, and cyclohexylamine salts and dicyclohexylamine salts of the above acids.

In addition, as the vaporizable amine-based rust-preventing agent, use can be made of one or more kinds from organic amine salts selected from phosphates, nitrites, carbonates, and carboxylates of mono-, di-, and tri-ethanolamine, n-, di-, and tert-butylamine, hexamethylenediamine, hexamethylenetetramine, mono- and di-cyclohexylamine, isopropylamine, oleylamine, naphthylamine, and diphenylamine. Note that the resin layer 1 does not contain a deliquescent rust-preventing agent in an amount that inhibits the effects of the present invention.

The content of the vaporizable amine and/or ammonia-based rust-preventing agent in the resin layer 1 is preferably 0.01 wt % or more, more preferably 0.10 wt % or more, and still more preferably 0.20 wt % or more with respect to the resin layer contained. In addition, it is preferably 10.00 wt % or less, more preferably 8.00 wt % or less, and still more preferably 6.00 wt % or less. In the case where the content is less than 0.01 wt %, it is difficult to exhibit a sufficient rust-preventing property, and in the case where the content is more than 10.00 wt %, molding is difficult.

The vaporizable amine and/or ammonia-based rust-preventing agent is contained in the resin layer 1 in a particulate form or in a state where it is dissolved in the resin layer. It may be in a particulate form or may be in a dissolved form. In the case where the rust-preventing agent is in the particulate form, an average particle diameter (d50) thereof is preferably 3 μm or more, more preferably 3 μm to 400 μm, still more preferably 3 μm to 200 μm, and most preferably 3 μm to 100 μm.

Further, a maximum particle diameter of the vaporizable amine and/or ammonia-based rust-preventing agent contained in the resin layer 1 is preferably 5000 μm or less, more preferably 3000 μm or less, and still more preferably 500 μm or less. In the case where the particle diameter of the vaporizable amine and/or ammonia-based rust-preventing agent is more than 5000 μm, there is a risk of a deterioration in strength of a resin molded product or contamination of metal products due to falling off of particles. The maximum particle diameter is the largest particle diameter among the measured particle diameters of 1000 particles.

In the case where the average particle diameter and/or the maximum particle diameter are within these ranges, the particles of the vaporizable amine and/or ammonia-based rust-preventing agent are formed into a convex portion covered with a resin on the surface of the resin layer 1. The presence of such a convex portion allows more gas for rust prevention to be generated, which contributes to improving the rust-preventing property. In addition, the convex portion on the surface of the film has an effect of preventing adhesion to an article to be rust-prevented, and can prevent the particles of the vaporizable amine and/or ammonia-based rust-preventing agent from coming into direct contact with the article to be rust-prevented, thereby preventing the surface of the article to be rust-prevented from being contaminated.

In addition, in the case where the vaporizable amine and/or ammonia-based rust-preventing agent is contained in the resin layer in a dissolved state and in the case where it is contained in the resin layer in a particulate form as described above, vaporability can be adjusted depending on the volatility and other properties of each kind of vaporizable rust-preventing agent.

With a series of steps of blending the particles of the vaporizable amine and/or ammonia-based rust-preventing agent into the resin constituting the resin layer, melting and kneading the resin, and forming it into, for example, a sheet shape, the powder of the vaporizable amine and/or ammonia-based rust-preventing agent before blending may be pulverized to reduce the average particle diameter. Therefore, the above-described average particle diameter in the present invention is a value relating to the vaporizable amine and/or ammonia-based rust-preventing agent contained in the resin layer 1 after the resin layer 1 is formed.

By containing the vaporizable amine and/or ammonia-based rust-preventing agent having a specific particle diameter or in a state of being dissolved in the resin, the amount of a rust-preventing gas generated can be controlled, and thereby the rust-preventing effect can be stably maintained for a long period of time.

In addition, the detailed mechanism is unclear, but it is thought that in the case where the particle diameter of the vaporizable amine and/or ammonia-based rust-preventing agent is set within a specific range, the convex portion is formed on the surface of the film, which provides the rust-preventing effect for a long period of time.

### (Resin Layer 2)

The resin layer 2 contains a deliquescent rust-preventing agent as the rust-preventing agent.

### (Deliquescent Rust-Preventing Agent)

The deliquescent rust-preventing agent in the present invention includes various metal nitrites and metal carbonates, and one or more kinds thereof can be used. As the metal nitrite, one or more kinds selected from a sodium salt, a potassium salt, a calcium salt, and a magnesium salt of nitrite can be used, and as the metal carbonate, a potassium salt and a hydrate thereof can be used.

The content of the deliquescent rust-preventing agent in the resin layer 2 is preferably 0.01 wt % or more, more preferably 0.10 wt % or more, and still more preferably 0.20 wt % or more. In addition, it is preferably 6.00 wt % or less, more preferably 4.00 wt % or less, and still more preferably 2.00 wt % or less. In the case where the content is less than 0.01 wt %, it may be difficult to exhibit a sufficient rust-preventing property, and in the case where the content is more than 6.00 wt %, the molding may be difficult, or it may be difficult to exhibit the rust-preventing property for a long period of time.

Note that the resin layer 2 in the rust-preventing film according to the present invention is obtained by containing the recycled resin composition for a rust-preventing film according to the present invention, and the total of the deliquescent rust-preventing agent contained in the recycled resin composition for a rust-preventing film, which is one of raw materials, and a deliquescent rust-preventing agent added as necessary is the total amount of the deliquescent rust-preventing agent contained in the resin layer 2 in the rust-preventing film.

In the case where the resin layer 2 is used as an outer layer in this manner to form a packaging bag or the like, moisture from the outside air is taken into the packaging bag, causing the deliquescent rust-preventing agent in the outer layer to react with the vaporizable amine and/or ammonia-based rust-preventing agent in the inner layer, which promotes the vaporization of the vaporizable amine and/or ammonia-based rust-preventing agent within the packaging, thereby exhibiting the rust-preventing effect. Further, by generating nitrous acid within the packaging, the rust-preventing effect can be improved.

(Vaporizable Amine and/or Ammonia-Based Rust-Preventing Agent)

In addition, the resin layer 2 contains 20 to 220 ppm by weight of a vaporizable amine and/or ammonia-based rust-preventing agent derived from a recycled resin composition for a rust-preventing film. The content of the vaporizable amine and/or ammonia-based rust-preventing agent in the resin layer 2 is preferably 60 ppm or more, more preferably 80 ppm or more, and still more preferably 120 ppm or more. In addition, it is preferably 200 ppm or less, more preferably 180 ppm or less, and still more preferably 160 ppm or less.

In the case where the content is more than 220 ppm, the vaporizable amine and/or ammonia-based rust-preventing agent may react with the deliquescent rust-preventing agent in the resin layer 2, which may result in foaming.

The vaporizable amine and/or ammonia-based rust-preventing agent derived from the recycled resin composition for a rust-preventing film referred to here may be the same compound as the vaporizable amine and/or ammonia-based rust-preventing agent contained in the resin layer 1 described above.

However, conventionally, it has not been common to contain both the vaporizable amine and/or ammonia-based rust-preventing agent and the deliquescent rust-preventing agent in one resin layer, due to the fear that the two may react with each other. However, as long as the content of the vaporizable amine and/or ammonia-based rust-preventing agent in the resin layer 2 is 20 ppm to 220 ppm, the reaction between the two can be effectively prevented. Therefore, the rust-preventing film according to the present invention can be formed by using the recycled resin composition for a rust-preventing film according to the present invention (which is basically a composition obtained by recycling the used rust-preventing film, raw materials thereof, or the like). Such a recycled resin composition for a rust-preventing film according to the present invention is not one in which the rust-preventing agent has been completely removed, but one in which the vaporizable amine and/or ammonia-based rust-preventing agent remains by reducing the treatment temperature, time, or the like since the degree of treatment is reduced to an extent that the vaporizable amine and/or ammonia-based rust-preventing agent remains to a certain extent.

Further, the vaporizable amine and/or ammonia-based rust-preventing agent derived from the recycled resin composition for a rust-preventing film, which is contained in the resin layer 2, may have an average particle diameter smaller than that of the vaporizable amine and/or ammonia-based rust-preventing agent contained in the recovered rust-preventing film.

### (Water)

Further, the resin layer 2 contains 400 ppm by weight or less of water derived from the recycled resin composition for a rust-preventing film. The content of the water in the resin layer 2 is preferably 380 ppm or less, more preferably 300 ppm or less, and still more preferably 200 ppm or less. In the case where the content is more than 400 ppm, there is a greater concern that the film foams.

### (Metal Carboxylate)

In the present invention, the resin layers 1 and 2 may or may not independently contain a metal carboxylate. The metal carboxylate may be either an aliphatic metal carboxylate or an aromatic metal carboxylate.

As the metal carboxylate, use can be made of one or more kinds from metal salts such as a sodium salt, a potassium salt, a calcium salt, and a magnesium salt of aliphatic carboxylic acids such as isobutyric acid, methacrylic acid, valeric acid, caproic acid, caprylic acid, capric acid, lauric acid, tridecylic acid, myristic acid, palmitic acid, stearic acid, sorbic acid, oleic acid, oleylic acid, isohexanoic acid, 2-methylpentanoic acid, 2-ethylbutanoic acid, isoheptanoic acid, isooctanoic acid, 2-ethylhexanoic acid, isononanoic acid, isodecanoic acid, 2-propylheptanoic acid, isoundecanoic acid, isododecanoic acid, 2-butyloctanoic acid, oxalic acid, malonic acid, succinic acid, glutaric acid, adipic acid, pimelic acid, suberic acid, azelaic acid, sebacic acid, undecanedicarboxylic acid, and dodecanedioic acid, and of aromatic carboxylic acids such as benzoic acid, aminobenzoic acid, salicylic acid, p-tert-butylbenzoic acid, o-sulfobenzoic acid, 1-naphthoic acid, 2-naphthoic acid, phthalic acid, isophthalic acid, terephthalic acid, and cinnamic acid.

The content of the metal carboxylate in the contained resin layer is preferably 0.001 wt % to 10.0 wt %, and more preferably 0.01 wt % to 5.0 wt %. In the case where the content is less than 0.001 wt %, it is difficult to exhibit a sufficient rust-preventing property, and in the case where the content is more than 10.0 wt %, the molding is difficult, and it is difficult to exhibit the rust-preventing property for a long period of time.

### (Carboxylic Acid)

In the present invention, the resin layers 1 and 2 may or may not independently contain a carboxylic acid. The carboxylic acid may be either an aliphatic carboxylic acid or an aromatic carboxylic acid.

As the carboxylic acid, use can be made of one or more kinds from aliphatic carboxylic acids such as isobutyric acid, methacrylic acid, valeric acid, caproic acid, caprylic acid, capric acid, lauric acid, tridecylic acid, myristic acid, palmitic acid, stearic acid, sorbic acid, oleic acid, oleylic acid, isohexanoic acid, 2-methylpentanoic acid, 2-ethylbutanoic acid, isoheptanoic acid, isooctanoic acid, 2-ethylhexanoic acid, isononanoic acid, isodecanoic acid, 2-propylheptanoic acid, isoundecanoic acid, isododecanoic acid, 2-butyloctanoic acid, oxalic acid, malonic acid, succinic acid, glutaric acid, adipic acid, pimelic acid, suberic acid, azelaic acid, sebacic acid, undecanedicarboxylic acid, and dodecanedioic acid, and of aromatic carboxylic acids such as benzoic acid, aminobenzoic acid, salicylic acid, p-tert-butylbenzoic acid, o-sulfobenzoic acid, 1-naphthoic acid, 2-naphthoic acid, phthalic acid, isophthalic acid, terephthalic acid, and cinnamic acid.

The content of the carboxylic acid in the contained resin layer is preferably 0.001 wt % to 10.0 wt %, and more preferably 0.01 wt % to 5.0 wt %. In the case where the content is less than 0.001 wt %, it is difficult to further improve the rust-preventing property, and in the case where the content is more than 10.0 wt %, the molding is difficult, and it is difficult to exhibit the rust-preventing property for a long period of time.

### (Benzotriazole-Based Compound and Tolyltriazole-Based Compound)

In the present invention, the resin layers 1 and 2 may or may not independently contain a benzotriazole-based compound and a tolyltriazole-based compound. Among these, one or more kinds selected from benzotriazole, 4-methylbenzotriazole, 5-methylbenzotriazole, and the like can be used.

The content of the benzotriazole-based compound and the tolyltriazole-based compound in the contained resin layer is preferably 0.001 wt % to 10.0 wt %, and more preferably 0.01 wt % to 5.0 wt %. In the case where the content is less than 0.001 wt %, it is difficult to further improve the rust-preventing property for a long period of time, and in the case where the content is more than 10.0 wt %, the molding is difficult, and it is difficult to exhibit the rust-preventing property for a long period of time.

### (Inorganic Acid Metal Salt)

In the present invention, the resin layers 1 and 2 may or may not independently contain an inorganic acid metal salt. Among these, one or more kinds selected from a metal borosilicate, a metal molybdate, and the like can be used. The content of the inorganic acid metal salt in the contained resin layer is preferably 0.001 wt % to 10.0 wt %, and more preferably 0.01 wt % to 5.0 wt %. In the case where the content is less than 0.001 wt %, it is difficult to further improve the rust-preventing property for a long period of time, and in the case where the content is more than 10.0 wt %, the molding is difficult, and it is difficult to exhibit the rust-preventing property for a long period of time.

### <Method for Producing Rust-Preventing Film>

In order to obtain the resin layer 2 containing the deliquescent rust-preventing agent in the present invention, a recycled resin composition recycled from a rust-preventing film including two layers, i.e., a resin layer containing a vaporizable amine and/or ammonia-based rust-preventing agent and a resin layer containing a deliquescent rust-preventing agent is used. The amount of the recycled resin composition for a rust-preventing film to be used in the resin layer 2 in the present invention is preferably 10.0 wt % or more, more preferably 15.0 wt % or more, still more preferably 20.0 wt % or more, and most preferably 25.0 wt % or more in the resin layer 2. The larger the blending amount, the more actively the recycled resin composition for a rust-preventing film recycled from the recovered rust-preventing film is utilized, which is preferred.

The rust-preventing film is produced by blending the polyolefin resin, the rust-preventing agent, and various additives, which are raw materials required for the resin layer 2, into the recycled resin composition for a rust-preventing film as necessary, and performing molding using a well-known film molding method such as extrusion molding, inflation molding, vacuum molding, or pressure molding.

Accordingly, the rust-preventing film can have any shape, such as a film, a sheet, a bag, a laminated sheet, a cylinder, or a box. At this time, the resin layers 1 and 2 may be formed by coextrusion to form a total of two or more layers. Alternatively, the resin layers 1 and 2 obtained separately may be laminated together by using known means such as adhesion or welding.

### <Use of Rust-Preventing Film>

The surface on the resin layer 1 side may be molded or processed into a bag shape such that it is positioned on the inner side of a container or packaging sheet, i.e., the side facing the article to be stored or packaged and protected from rust, or conversely, the surface on the resin layer 2 side may be molded or processed into a bag shape such that it is positioned on the inner side of a container or packaging sheet, i.e., the side facing the article to be stored or packaged and protected from rust.

However, the vaporizable amine and/or ammonia-based rust-preventing agent may have the property of being pulverized to a small average particle diameter while being added to the resin and kneaded and during the molding step. Therefore, when the particle diameter is to be controlled, attention must be paid to the average particle diameter after molding.

Further, in the case where at least two resin layers are used, moisture gradually penetrates from the surface of the resin layer 2 to the inside and the rust-preventing gas is also gradually generated, so that a high rust-preventing effect can be maintained stably for a long period of time without the need to add a rust-preventing slow-release agent such as a carboxylic acid-modified polyolefin-based polymer, a wax, a nonionic surfactant, and an inorganic porous material.

In addition, the article to be rust-prevented can include a wide range of articles, such as cast iron, steel plates, and galvanized steel plates, which are known to be packaged for rust prevention using the rust-preventing film or a bag obtained therefrom.

### Examples and Comparative Examples

Recovered rust-preventing films 1 and 2 shown in Table 1 (including two layers, i.e., a resin layer containing a vaporizable amine and/or ammonia-based rust-preventing agent and a resin layer containing a deliquescent rust-preventing agent) were prepared. Next, 50 kg of each of these rust-preventing films 1 and 2 was pulverized separately, melted at 140° C. or 240° C., and granulated into pellets having a diameter of approximately 5 mm, and then, if necessary, dried at 90° C. for 120 minutes to reduce the contents of the vaporizable amine and/or ammonia-based rust-preventing agent and water. Table 2 shows the conditions for melting, kneading, and drying recycled resins A to g obtained in this manner, and the contents of the vaporizable amine and/or ammonia-based rust-preventing agent, the deliquescent rust-preventing agent, and the water in the recycled resin and in the recovered rust-preventing film.

The recycled resins e to g are examples in which drying was not performed after melting and granulating at 140° C. In this case, even when the amounts of ammonium benzoate or cyclohexylamine carbamate (CHC), sodium nitrite, and water in the recovered rust-preventing films are the same, the contents of the rust-preventing agent and the water in the recycled resins are not constant. The reason for this is unclear, but it is thought to be related to a low melting temperature and whether drying was performed.

Further, a polyethylene (PE), each rust-preventing agent, and the recycled resin shown in Table 2 were blended such that the compositions of the obtained resin layers 1 and 2 were as shown in Table 3 below.

Each component was inflation-molded at 140° C. to form the resin layer 1 and the resin layer 2 shown in Table 3 below, thereby obtaining rust-preventing films having the layer configurations shown in Table 3. The presence or absence of foaming, the YI, the ΔYI, and the rust-preventing performance of these rust-preventing films were determined as follows. The results are shown in Table 4. In Table 3, the total of each component contained in each layer is the total including the component derived from the recycled resin in the layer containing the recycled resin. The content of the component derived from the recycled resin is shown as a part of the total of each component. In addition, the resin layer 3 in Table 3 corresponds to the outermost layer that does not contain a rust-preventing agent.

### (Presence or Absence of Foaming)

Method: visually check for the presence or absence of foaming

### (YI and ΔYI)

Sample: one obtained by stacking 12 rust-preventing films
Measured value: average value of five measured values per sample
Device: spectrophotometer SD-7000 from NIPPON DENSHOKU INDUSTRIES Co., Ltd.
Light source: specularly reflected light (SCI)
Measurement method: According to the standard in ASTM D1925, 12 rust-preventing films were stacked, five points of one sample were measured, and the average value was taken as YI.
ΔYI represents a difference between YI₀ of the recovered rust-preventing film 1 or 2 and YI_{X} of the rust-preventing film 1 or 2 using the recycled resin composition for a rust-preventing film (Equation 1).

ΔYI=(YI_{X} of rust-preventing film 1 or 2 using recycled resin composition for rust-preventing film)−(YI₀ of recovered rust-preventing film 1 or 2) (Equation 1)

Note that, by measuring 12 films stacked together, there is a smaller variation in the measured values and a larger YI can be measured compared to measuring each film individually, making it possible to measure a color change with high accuracy.

### (Rust-Preventing Performance)

A test piece described in the following [A] was hung with a nylon fishing line within a frame measuring 100 mm in length×100 mm in width×150 mm in height, and the frame was gusset-sealed with the prepared film and sealed up.

This test form was placed in a test environment described in the following [B] for a specified period of time, and then the state of surface rust was evaluated based on the evaluation method described in the following [C].

### [A] Test Piece

Cast iron (JIS G 5501), size: 30 mm in diameter×8 mm

### [B] Test Environment

Cycle test conditions (12 hours/1 cycle)
Maintain at 25° C. and 70% RH (4 hours)→transition to 50° C. and 95% RH (2 hours)→maintain at 50° C. and 95% RH (4 hours)→transition to 25° C. and 70% RH (2 hours)

### [C] Evaluation Method

Duration: 3 days (6 cycles)

### Criteria:

No: no rust or color change
Yes: rust spots and color change

The content of each rust-preventing agent in the rust-preventing film and the recycled resin composition in Tables 1, 2 and 3 was determined as follows.

### (Common Measurement Conditions)

Measurement method: HPLC method
Detector: Shodex CD-5 electrical conductivity detector for ion chromatography
Concentration: calculated based on peak area by using previously prepared calibration curve

### (Measurement Conditions for Content of Sodium Nitrite)

The rust-preventing pellet/rust-preventing film (10 g) was added to a mixed solution of 100 g of water and 100 mL of xylene, followed by stirring and dissolution at 80° C., the resin and the rust-preventing agent component were separated, and the solution was cooled to room temperature to obtain an aqueous solution consisting only of the rust-preventing agent component and water. The aqueous solution was measured under the following measurement conditions.

### Measurement Conditions

Column used: Shodex IC I-524 (protection column IC IA-G)
Eluent: phthalic acid aqueous solution (2.5 mM)
Flow rate: 1.5 mL/min.

### (Measurement Conditions for Content of Ammonium Benzoate)

The rust-preventing pellet/rust-preventing film (10 g) was added to a mixed solution of 100 g of water and 100 mL of xylene, followed by stirring and dissolution at 80° C., the resin and the rust-preventing agent component were separated, and the solution was cooled to room temperature to obtain an aqueous solution consisting only of the rust-preventing agent component and water. The aqueous solution was measured under the following measurement conditions.

### Measurement Conditions

Column used: Shodex IC YK-421 (protection column IC YK-G)
Eluent: tartaric acid aqueous solution (5 mM)
Flow rate: 1.0 mL/min.

### (Measurement Conditions for Content of Cyclohexylamine Carbamate (CHC))

The rust-preventing pellet/rust-preventing film (10 g) was added to a mixed solution of 150 g of a 10 mM nitric acid aqueous solution and 30 mL of xylene, followed by stirring and dissolution at 80° C., the resin and the rust-preventing agent component were separated, and the solution was cooled to room temperature to obtain an aqueous solution consisting only of the rust-preventing agent component and water. The aqueous solution was measured under the following measurement conditions.

### Measurement Conditions

Column used: Shodex IC YK-421 (protection column IC YK-G)
Eluent: mixed solution of 1 mM nitric acid aqueous solution and acetonitrile in mixing ratio of 3:7
Flow rate: 1.0 mL/min.

The amount of water in the rust-preventing film and the recycled resin composition in Tables 1, 2 and 3 was measured by using a Karl Fischer moisture meter (AQV-2200S manufactured by HIRANUMA Co., Ltd.).

TABLE 1

| Rust-preventing | Content (wt %) of each component in entire rust-preventing film | | | |
|---|---|---|---|---|
| film | Ammonium benzoate | CHC | Sodium nitrite | Water |
| Film 1 | 0.87 | | 0.48 | 0.65 |
| Film 2 | | 0.40 | 0.30 | 0.43 |

| | Property and component (wt %) of each layer in rust-preventing film | | | | | | |
|---|---|---|---|---|---|---|---|
| Rust-preventing | | Resin | Thickness | | Ammonium | | Sodium |
| film | | layer | (μm) | PE | benzoate | CHC | nitrite |
| Film 1 | Inner layer | Resin | 32 | 97.8 | 2.2 | | |
| | | layer 1 | | | | | |
| | Outer layer | Resin | 48 | 99.2 | | | 0.8 |
| | | layer 2 | | | | | |
| Film 2 | Inner layer | Resin | 30 | 99.0 | | | 1.0 |
| | | layer 2 | | | | | |
| | Intermediate | Resin | 40 | 99.0 | | 1.0 | |
| | | layer 1 | | | | | |
| | Outer layer | Resin | 30 | 100.0 | | | |
| | | layer 3 | | | | | |

| Rust-preventing | Property of rust-preventing film | | |
|---|---|---|---|
| film | Presence or absence of foaming | YI₀ | Presence or absence of rust |
| Film 1 | No | 5 | No |
| Film 2 | No | 8 | No |

TABLE 2

| | Recovered | Recycling treatment conditions | | | |
|---|---|---|---|---|---|
| | rust- | Melting and kneading | | Drying conditions | |
| Recycled | preventing | conditions | | Temperature | Time |
| resin | film | Temperature (°C) | Vent | (°C) | (min) |
| A | 1 | 240 | Yes | 90 | 120 |
| B | 2 | 240 | Yes | 90 | 120 |
| C | 1 | 240 | Yes | No | No |
| D | 1 | 140 | No | 90 | 120 |
| e | 1 | 140 | No | No | No |
| f | 1 | 140 | No | No | No |
| g | 1 | 140 | No | No | No |

| Recycled | Component contained in recycled resin (excluding PE) (wt %) | | | |
|---|---|---|---|---|
| resin | Ammonium benzoate | CHC | Sodium nitrite | Water |
| A | 0.04 | | 0.10 | 0.04 |
| B | | 0.04 | 0.05 | 0.03 |
| C | 0.06 | | 0.10 | 0.23 |
| D | 0.11 | | 0.21 | 0.03 |
| e | 0.15 | | 0.21 | 0.31 |
| f | 0.24 | | 0.12 | 0.22 |
| g | 0.23 | | 0.13 | 0.32 |

TABLE 3

| | Rust-preventing film | | | | | |
|---|---|---|---|---|---|---|
| | | | Thickness | Recycled resin | | Amount (wt %) of |
| | | Resin layer | (μm) | and content (wt %) | | newly blended PE |
| Ex. 1 | Inner layer | Resin layer 1 | 32 | | | 97.8 |
| | Outer layer | Resin layer 2 | 48 | A | (16.5) | 82.7 |
| Ex. 2 | Inner layer | Resin layer 1 | 32 | | | 97.8 |
| | Outer layer | Resin layer 2 | 48 | A | (33.0) | 66.2 |
| Ex. 3 | Inner layer | Resin layer 1 | 32 | | | 97.8 |
| | Outer layer | Resin layer 2 | 48 | A | (50.0) | 49.2 |
| Ex. 4 | Inner layer | Resin layer 1 | 32 | | | 97.8 |
| | Outer layer | Resin layer 2 | 48 | C | (16.5) | 82.7 |
| Ex. 5 | Inner layer | Resin layer 1 | 32 | | | 97.8 |
| | Outer layer | Resin layer 2 | 48 | D | (16.5) | 82.7 |
| Ex. 6 | Inner layer | Resin layer 2 | 30 | B | (50.0) | 49.0 |
| | Intermediate | Resin layer 1 | 40 | | | 99.0 |
| | layer | | | | | |
| | Outer layer | Resin layer 3 | 30 | | | 100.0 |
| Comp. | Inner layer | Resin layer 1 | 32 | C | (33.0) | 64.8 |
| Ex. 1 | Outer layer | Resin layer 2 | 48 | | | 99.2 |
| Comp. | Inner layer | Resin layer 1 | 32 | D | (33.0) | 64.8 |
| Ex. 2 | Outer layer | Resin layer 2 | 48 | | | 99.2 |
| Comp. | Inner layer | Resin layer 1 | 32 | | | 97.8 |
| Ex. 3 | Outer layer | Resin layer 2 | 48 | A | (66.7) | 32.5 |
| Comp. | Inner layer | Resin layer 1 | 32 | | | 97.8 |
| Ex. 4 | Outer layer | Resin layer 2 | 48 | e | (16.5) | 82.7 |
| Comp. | Inner layer | Resin layer 1 | 32 | | | 97.8 |
| Ex. 5 | Outer layer | Resin layer 2 | 48 | f | (16.5) | 82.7 |
| Comp. | Inner layer | Resin layer 1 | 32 | | | 97.8 |
| Ex. 6 | Outer layer | Resin layer 2 | 48 | g | (16.5) | 82.7 |

| | Rust-preventing film | | | | | | | |
|---|---|---|---|---|---|---|---|---|
| | | Total of each component | | | | | | |
| | | contained in each layer | | | Component derived from | | | |
| | | Total | | Total | recycled resin | | | |
| | | ammonium | Total | sodium | Ammonium | | Sodium | |
| | | benzoate | CHC | nitrite | benzoate | CHC | nitrite | Water |
| | | (wt %) | (wt %) | (wt %) | (ppm) | (ppm) | (ppm) | (ppm) |
| Ex. 1 | Inner layer | 2.2 | | | | | | |
| | Outer layer | | | 0.8 | 66 | | 165 | 66 |
| Ex. 2 | Inner layer | 2.2 | | | | | | |
| | Outer layer | | | 0.8 | 132 | | 330 | 132 |
| Ex. 3 | Inner layer | 2.2 | | | | | | |
| | Outer layer | | | 0.8 | 200 | | 500 | 200 |
| Ex. 4 | Inner layer | 2.2 | | | | | | |
| | Outer layer | | | 0.8 | 99 | | 165 | 380 |
| Ex. 5 | Inner layer | 2.2 | | | | | | |
| | Outer layer | | | 0.8 | 182 | | 347 | 50 |
| Ex. 6 | Inner layer | | | 1.0 | | 200 | | 150 |
| | Intermediate | | 1.0 | | | | 250 | |
| | layer | | | | | | | |
| | Outer layer | | | | | | | |
| Comp. | Inner layer | 2.2 | | | 198 | | 330 | 759 |
| Ex. 1 | Outer layer | | | 0.8 | | | | |
| Comp. | Inner layer | 2.2 | | | 363 | | 693 | 99 |
| Ex. 2 | Outer layer | | | 0.8 | | | | |
| Comp. | Inner layer | 2.2 | | | | | | |
| Ex. 3 | Outer layer | | | 0.8 | 266 | | 667 | 267 |
| Comp. | Inner layer | 2.2 | | | | | | |
| Ex. 4 | Outer layer | | | 0.8 | 248 | | 347 | 512 |
| Comp. | Inner layer | 2.2 | | | | | | |
| Ex. 5 | Outer layer | | | 0.8 | 396 | | 198 | 363 |
| Comp. | Inner layer | 2.2 | | | | | | |
| Ex. 6 | Outer layer | | | 0.8 | 380 | | 215 | 528 |

TABLE 4

| | Presence or absence | | | Presence or |
|---|---|---|---|---|
| | of foaming | YIx | ΔYI | absence of rust |
| Ex. 1 | No | 18 | 13 | No |
| Ex. 2 | No | 25 | 20 | No |
| Ex. 3 | No | 30 | 25 | No |
| Ex. 4 | No | 18 | 13 | No |
| Ex. 5 | No | 18 | 13 | No |
| Ex. 6 | No | 29 | 21 | No |
| Comp. Ex. 1 | Yes | 40 | 35 | Not performed |
| Comp. Ex. 2 | Yes | 42 | 37 | Not performed |
| Comp. Ex. 3 | Yes | 38 | 33 | Not performed |
| Comp. Ex. 4 | Yes | 37 | 32 | Not performed |
| Comp. Ex. 5 | Yes | 42 | 37 | Not performed |
| Comp. Ex. 6 | Yes | 47 | 42 | Not performed |

Each Example is an example in which the recycled resin composition for a rust-preventing film was used as a material for obtaining the resin layer 2, and which was formulated to contain 20 ppm to 220 ppm of ammonium benzoate or CHC and 400 ppm or less of water, which were components derived from the recycled material. According to each Examples of the present invention, no foaming is observed in the rust-preventing film, and a predetermined amount of each rust-preventing agent can be contained. In addition, the rust-preventing performance was similar to that of the films 1 and 2, and no rust was observed.

Comparative Examples 1 and 2 are examples in which the recycled resin composition for a rust-preventing film was used as a material for obtaining the resin layer 1. In addition, Comparative Examples 3 to 6 are examples in which the recycled resin composition for a rust-preventing film was used as a material for obtaining the resin layer 2, and which were formulated to contain more than 220 ppm of ammonium benzoate and/or more than 400 ppm of water.

As in Comparative Examples 1 and 2, in the case where the resin layer 1 contained the recycled resin composition for a rust-preventing film, foaming was observed in the resin layer 1. In addition, as in Comparative Examples 3 to 6, in the case where the recycled resin composition for a rust-preventing film was contained in the resin layer 2 in an amount more than a predetermined amount, foaming was observed. In addition, it is found that in order to use the recycled resin compositions e to g used in Comparative Examples 4 to 6 as the rust-preventing film in the same manner as in Examples, the content of the recycled resin compositions e to g has to be reduced, and as a result, the amount of the recycled resin composition that can be blended into the rust-preventing film has to be reduced.

In addition, both the film 1 and the film 2 in Table 1 do not contain the recycled resin composition for a rust-preventing film according to the present invention, but are rust-preventing films obtained by using materials none of which is derived from reuse. The YI₀ of the films 1 and 2 are 5 and 8, respectively. These are films used as criteria in determining the ΔYI, which indicates the degree of yellowing.

The YI_{X} value in Table 4 is 30 or less in each Example, but is at least 37 in each Comparative Example. In addition, the ΔYI value is 25 or less in each Example, but is at least 32 in each Comparative Example. These results show that the rust-preventing film according to the present invention exhibited a smaller degree of yellowing. In each Comparative Example, the degree of yellow discoloration was large.

In addition, the rust-preventing film in each Example exhibited a rust-preventing property similar to that of the rust-preventing films 1 and 2 having the same composition but not containing a recycled resin. Note that, since foaming was observed and the degree of yellowing was large in the rust-preventing film in each Comparative Example, the rust-preventing property was not evaluated.

1. A recycled resin composition for a rust-preventing film, comprising:
a polyolefin resin;
0.02 wt % to 0.20 wt % of a vaporizable amine and/or ammonia-based rust-preventing agent;
a deliquescent rust-preventing agent; and
0.30 wt % or less of water.

2. A method for producing a recycled resin composition for a rust-preventing film, comprising:
melting, kneading, and, if necessary, drying a rust-preventing film having a laminated structure including a polyolefin resin layer containing a vaporizable amine and/or ammonia-based rust-preventing agent and a polyolefin resin layer containing a deliquescent rust-preventing agent, wherein
the recycled resin composition for a rust-preventing film contains a polyolefin resin, 0.02 wt % to 0.20 wt % of the vaporizable amine and/or ammonia-based rust-preventing agent, the deliquescent rust-preventing agent, and 0.30 wt % or less of water.

3. A rust-preventing film comprising:
a laminated structure including a polyolefin resin layer 1 containing a vaporizable amine and/or ammonia-based rust-preventing agent and a polyolefin resin layer 2 containing a deliquescent rust-preventing agent, wherein
the polyolefin resin layer 2 contains a polyolefin resin, 20 ppm to 220 ppm of a vaporizable amine and/or ammonia-based rust-preventing agent, and 400 ppm or less of water, which are derived from a recycled resin composition for a rust-preventing film.

4. The rust-preventing film according to claim 3, wherein a YI value measured by stacking 12 rust-preventing films is 35.0 or less.

5. A method for producing a rust-preventing film, the rust-preventing film having a laminated structure including a polyolefin resin layer 1 containing a vaporizable amine and/or ammonia-based rust-preventing agent and a polyolefin resin layer 2 containing a deliquescent rust-preventing agent, the method comprising:
mixing the polyolefin resin layer 2 with a recycled resin composition for a rust-preventing film, a polyolefin resin, and a deliquescent rust-preventing agent, to contain 20 ppm to 220 ppm of the vaporizable amine and/or ammonia-based rust-preventing agent and 400 ppm 5 or less of water, which are derived from the recycled resin composition.
